(19) United States
(12) Patent Application Publication
(10) Pub. No.: US 2013/0043366 A1
(43) Pub. Date: Feb. 21, 2013

(54) APPARATUS TO SUBSTANTIALLY MINIMIZE ACCIDENTAL TIPPING OF A CONTAINER PARTIALLY FILLED WITH A LIQUID

(71) Applicant: Samuel C. McCaslin, Pittsburgh, PA (US)

(72) Inventor: Samuel C. McCaslin, Pittsburgh, PA (US)

(73) Assignee: MCCASLIN INNOVATIONS, LLC, Pittsburgh, PA (US)

(21) Appl. No.: 13/695,717

(22) PCT Filed: May 5, 2011
(86) PCT No.: PCT/US2011/035359

§ 371 Date: Nov. 1, 2012

Related U.S. Application Data
(60) Provisional application No. 61/331,606, filed on May 5, 2010.

(51) Int. Cl. B60N 3/00; B60N 3/10

(52) U.S. Cl. 248/346.03; 224/544; 248/346.11

(57) ABSTRACT

An apparatus to substantially minimize accidental tipping of a container partially filled with a liquid. The apparatus includes a first portion engageable with at least one of a tray, a coaster, a cup holder disposed in a vehicle and said container and a second portion disposed one of in and on one of the tray, coaster and cup holder the first portion is disposed on the container and on the container when the first portion is disposed one of in and on such one of the tray, coaster and cup holder.

### CROSS REFERENCED TO RELATED APPLICATION

This application is related to U.S. Provisional Patent Application Ser. No. 61/331,606 filed May 5, 2010.

### FIELD OF THE INVENTION

The present invention relates, in general, to a container for holding pre-selected liquids and, more particularly, this invention relates to an apparatus to substantially minimize accidental tipping of the container when it is at least partially filled with a liquid.

### BACKGROUND OF THE INVENTION

Prior to the conception and development of the instant invention, as is generally well known in the prior art, the accidental tipping of a container filled with a liquid is a relatively frequent occurrence. This is particularly the case with small children and the elderly.

Holders to prevent the tipping of containers that are known to applicant and are presently available on the market are generally permanently connected to or disposed within a device such as an automobile. Such holders are further designed to hold only drink containers. It is believed that it would be desirable to have a holder to prevent the tipping of containers that is portable and, in addition to holding drink containers, offer designs that hold containers other than a drink container.

One such design was taught in my prior patent applications bearing Ser. Nos. 10/437,817 and 10/613,243, filed on May 14, 2003, and Jul. 3, 2003, respectively. The problem with these designs is that the container must be twisted in order to either insert it into the holder and/or to remove it from the holder.

No prior art inventions which applicant is currently aware of offer the anti-tipping ability while lifting the container straight up to remove it from the holder and placing the container back into the holder without having to twist it.

### BRIEF SUMMARY OF THE INVENTION

The present invention provides an apparatus to substantially minimize accidental tipping of a container at least partially filled with a preselected liquid. The apparatus includes a first portion engageable with at least one of a tray, a coaster, a cup holder disposed in a vehicle and the container. The first portion includes a generally round hollow member that has each of a first predetermined width, an outer surface having a first predetermined diameter and an inner surface having a second predetermined diameter. The first portion further includes a first predetermined plurality of gear like teeth, having a predetermined pitch, formed at least one of in and on the inner surface of said generally round hollow member. There is an annular member disposed on and extending outwardly from the outer surface of the generally round hollow member at a predetermined location. Such annular member is preferably generally rectangular in cross section. Additionally, the first portion includes a first means having at least a portion of an upper surface thereof disposed below and engageable with a bottom surface of the annular member for each of providing assistance in retaining the generally round hollow member in place and enabling such generally round hollow member to rotate thereover. A second means having at least a portion of a bottom surface thereof disposed above and facing an upper surface of said annular member is provided for providing assistance in retaining the generally round hollow member in place. The final essential element of the first portion of the apparatus is a third means engageable with each of the first means and the second means for maintaining a predetermined distance between the at least a portion of such upper surface of the first means and the at least a portion of the bottom surface of such second means. The final essential element of the apparatus is a second portion disposed one of in and on one of the tray, coaster and cup holder when the first portion is disposed on such container and on the container when such first portion is disposed one of in and on the one of such tray, coaster and cup holder. The second portion has a second predetermined plurality of gear like teeth disposed on a generally round member disposed on an outer surface thereof and having a predetermined pitch for mating engagement with the first predetermined plurality of teeth.

### OBJECTS OF THE INVENTION

It is, therefore, one of the primary objects of the present invention to provide an apparatus that is useful as either a portable or a stationary holding device and which will substantially minimize the accidental tipping of a container at least partially filled with a liquid.

Another object of the present invention is to provide an apparatus which substantially minimizes tipping of a container that includes a means for one of releasably and permanently securing the apparatus to a pre-selected smooth surface.

Still another object of the present invention is to provide an apparatus which substantially minimizes tipping of a container that is relatively easy to use.

Yet another object of the present invention is to provide an apparatus which substantially minimizes tipping of a container that is relatively inexpensive to manufacture.

A further object of the present invention is to provide an apparatus which substantially minimizes tipping of a container that can be used in a variety of applications, such as, a lap top tray, a cafeteria type tray, a coaster, a cup holder disposed in a vehicle and a tray attached to a ladder.

An additional object of the present invention is to provide an apparatus which substantially minimizes tipping of a container that does not require twisting the container to remove it from the apparatus.

Still yet another object of the present invention is to provide an apparatus which substantially minimizes tipping of a container incorporated into a lap top tray having one of a pre-selected image disposed on the upper surface of the tray.

It is a still further object of the present invention to provide an apparatus which substantially minimizes tipping of a container that can be retrofitted for a variety of applications.

In addition to the several objects and advantages of the instant invention which have been specifically described in detail above, it should be noted that various other objects and advantages of the present invention will become more readily apparent to persons who are skilled in the same and related arts from the following more detailed description of the invention, particularly, when such description is taken in conjunction with the attached drawing figures and the appended claims.

### BRIEF DESCRIPTION OF THE DRAWINGS

FIG. 1 is a cross sectional view of one of the presently preferred embodiments of the invention for use with a tray;

FIG. 2A is a side elevation view of a container equipped with an alternative embodiment of a portion of an external gear assembly attached thereto;

FIG. 2B is a side elevation view of a gear for attachment to the container illustrated in FIG. 2A;

FIG. 2C is a side elevation view of the container illustrated in FIG. 2A having the gear illustrated in FIG. 2B attached thereto;

FIG. 3 is a side view of a coaster equipped with a presently preferred embodiment of the present invention;

FIGS. 4A-D are views illustrating a presently preferred embodiment of the apparatus as it will be used in a vehicle cup holder (not shown);

FIGS. 5A-C are views illustrating a container swivel type receiver assembly;

FIGS. 6A-B are views illustrating a permanent type swivel assembly which can be used on cafeteria style trays as well as airline drop down trays;

FIGS. 7A-B are views illustrating an alternative embodiment of an apparatus for use in a cup holder of an automobile;

FIGS. 8A-B are views illustrating another alternative embodiment of the invention having a snap lock connection for use with a tray;

FIG. 9 is a view illustrating a permanent swiveling gear like assembly which can be mounted to either a container or another surface;

FIG. 10 is a view illustrating a permanent non-swiveling gear like assembly which can be mounted to either a container or another surface;

FIGS. 11-14 illustrate a number of alternative embodiments of the invention having a mobile swiveling gear like assembly; and

FIGS. 15A-C illustrate an embodiment of the invention for connection to a paper cup.

### BRIEF DESCRIPTION OF THE PRESENTLY PREFERRED AND VARIOUS ALTERNATIVE EMBODIMENTS OF THE INVENTION

Prior to proceeding to the more detailed description of the present invention, it should be noted that identical components having identical functions have been identified with identical reference numerals throughout the several views illustrated in the attached drawing figures.

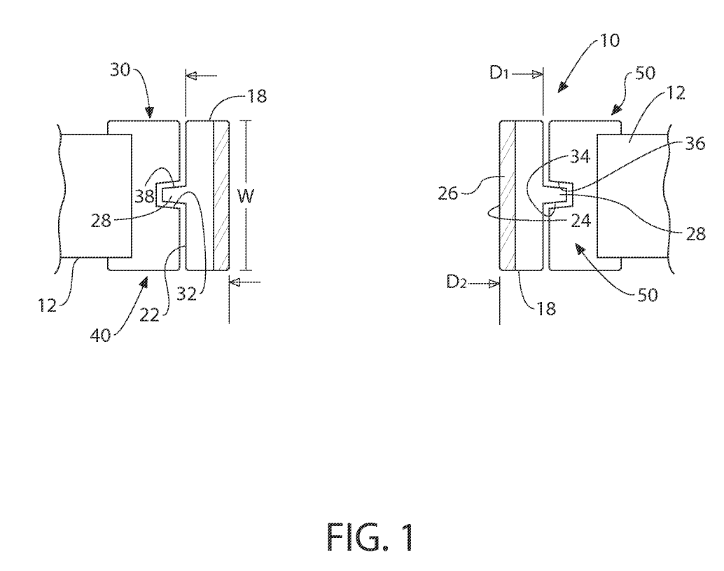

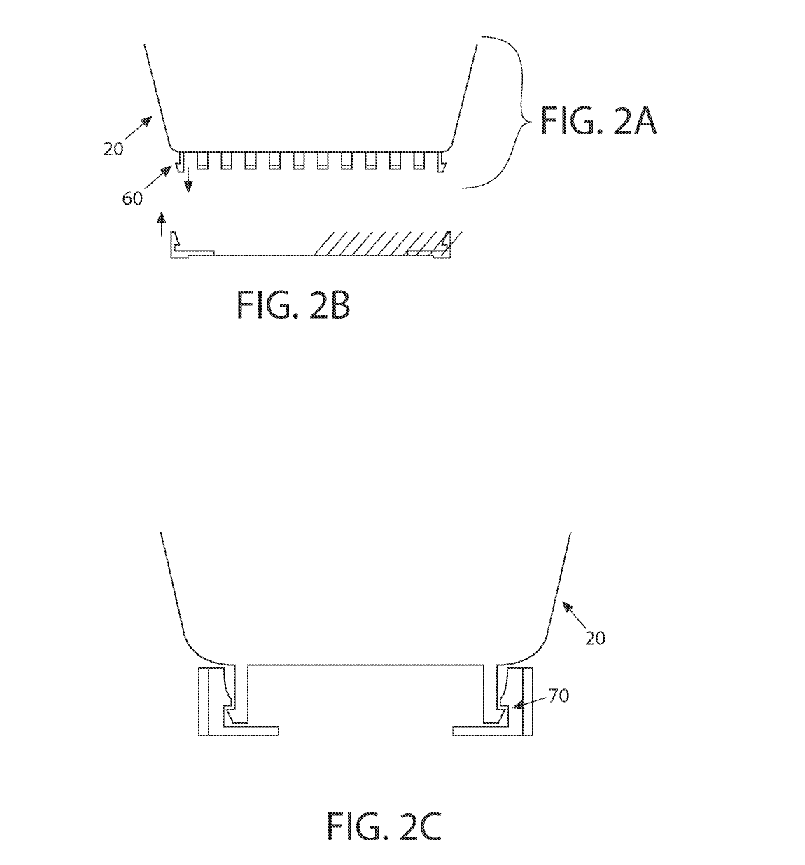

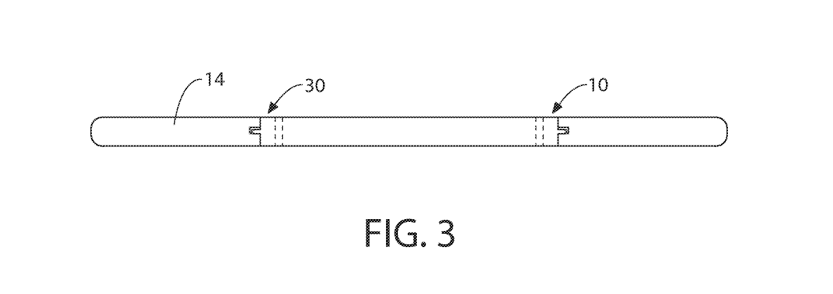

Now reference is made more particularly to drawing FIGS. 1, 2A-C and 3. Illustrated therein are two of the presently preferred embodiments of an apparatus, generally designated 10, which will substantially minimize accidental tipping of a container (FIGS. 2A and 2C), generally designated 20, which is at least partially filled with a liquid.

The apparatus 10 comprises a first portion, generally designated 30, engageable with at least one of a tray 12, a coaster 14, a cup holder (not shown) disposed in a vehicle (not shown) and the container 20. The first portion 30 includes a generally round hollow member 18 having each of a first predetermined width (W), an outer surface 22 having a first predetermined diameter (D1) and an inner surface 24 having a second predetermined diameter (D2).

The first portion 30 further includes a first predetermined plurality of gear like teeth 26, having a predetermined pitch, formed at least one of in and on the inner surface 24 of the generally round hollow member 18. There is an annular member 28 disposed on and extending outwardly from the outer surface 22 of the generally round hollow member 18 at a predetermined location. The annular member 28, in one presently preferred embodiment, has a generally rectangular cross section and is located about midway between the width W of the generally hollow member 18, although it could be positioned closely adjacent one edge thereof.

The first portion 30 further includes a first means, generally designated 40, having at least a portion of an upper surface 32 thereof disposed below and engageable with a bottom surface 34 of the annular member 28 for each of providing assistance in retaining the generally round hollow member 18 in place and enabling such generally round hollow member 18 to rotate thereover. A second means, generally designated 50, is also provided. Second means 50 has at least a portion of a bottom surface 36 thereof disposed above and facing an upper surface 38 of the annular member 28 for providing assistance in retaining the generally round hollow member 18 in place. The final essential component of the first portion 30 of apparatus 10 is a third means, generally designated 60, for engaging with each of the first means 40 and the second means 50 for maintaining a predetermined distance between the at least a portion of the upper surface 32 of such first means 40 and the at least a portion of the bottom surface 36 of such second means 50. Preferably third means 60 is a friction fit.

The final essential element of the apparatus 10 is a second portion, generally designated 70, disposed one of in and on one of the tray 12, coaster 14 and cup holder 16 when the first portion 30 is disposed on the container 20 and on such container 20 when the first portion 30 is disposed one of in and on such one of such tray 12, coaster 14 and cup holder 16. The second portion 70 has a second predetermined plurality of gear like teeth 42 disposed on a generally round member 44 disposed on an outer surface 46 thereof and having a predetermined pitch for mating engagement with the first predetermined plurality of teeth 26. Preferably, the second portion 70 will be disposed on the container 20.

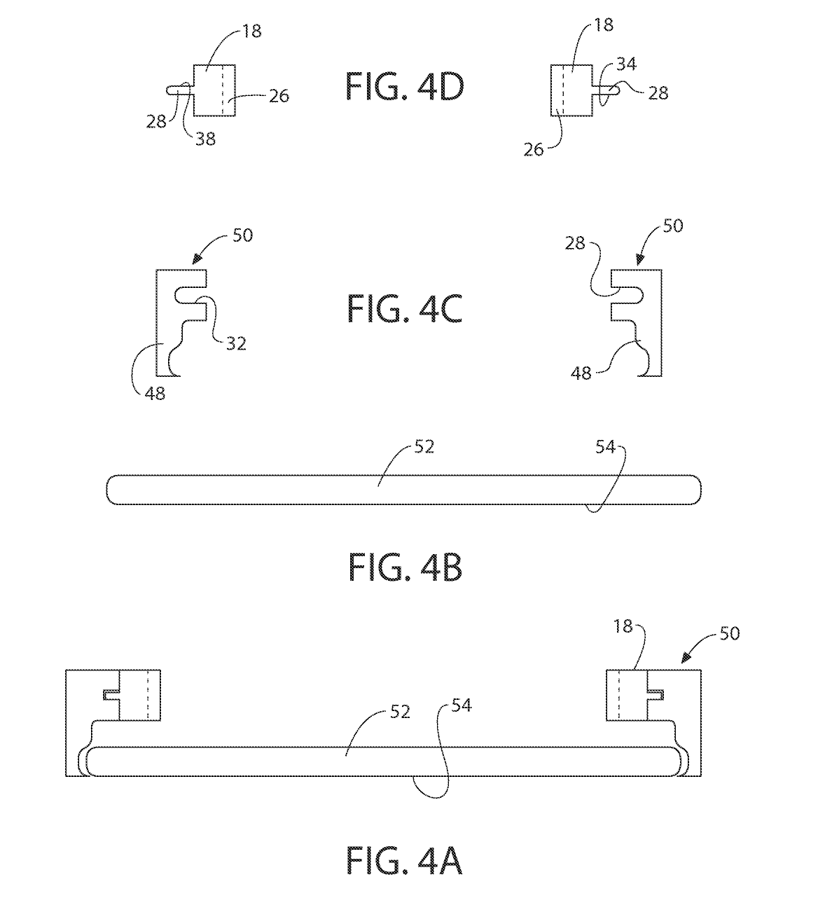

Reference is now made to FIGS. 4A-D. Illustrated therein is an alternative embodiment of the first portion 30 of apparatus 10 as it would be used in a vehicle cup holder (not shown). In this embodiment second means 50 includes finger like member 48 engageable with a permanent base 52. Base 52 has an adhesive surface 54 disposed on the bottom surface thereof for adhering base 52 to the bottom of the vehicle cup holder.

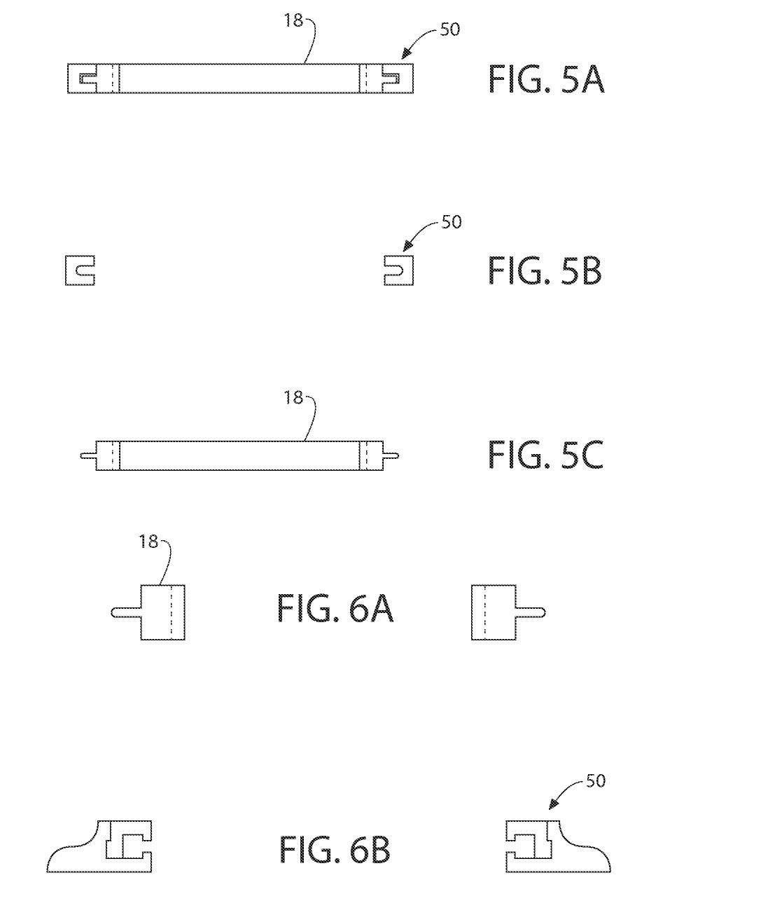

FIGS. 5A-C are views illustrating a container 20 swivel type receiver assembly 50 for gear like member 18.

FIGS. 6A-B are views illustrating a permanent type swivel assembly 50 which can be used on cafeteria style trays (not shown) as well as airline drop down trays (not shown).

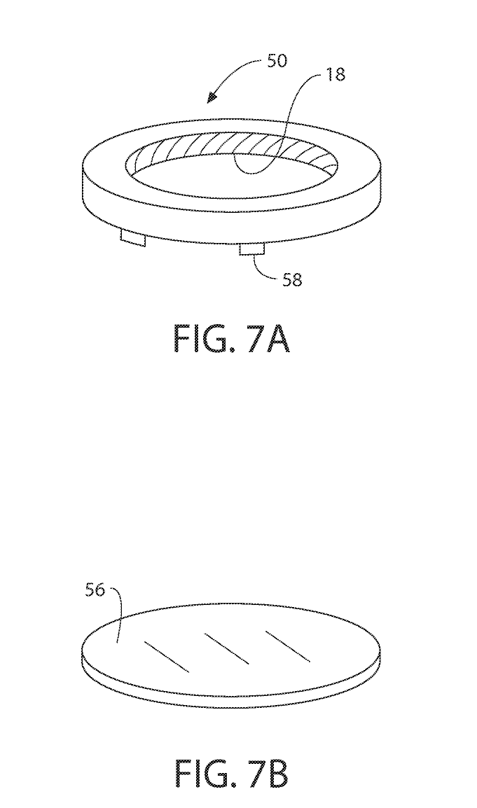

FIGS. 7A-B are views illustrating an alternative embodiment of an apparatus for use in a cup holder of an automobile. In this embodiment a series of magnets 58 are adhered to the bottom of the receiver assembly 50 for attraction to a metal plate 56 adhered to the bottom of the vehicle cup holder.

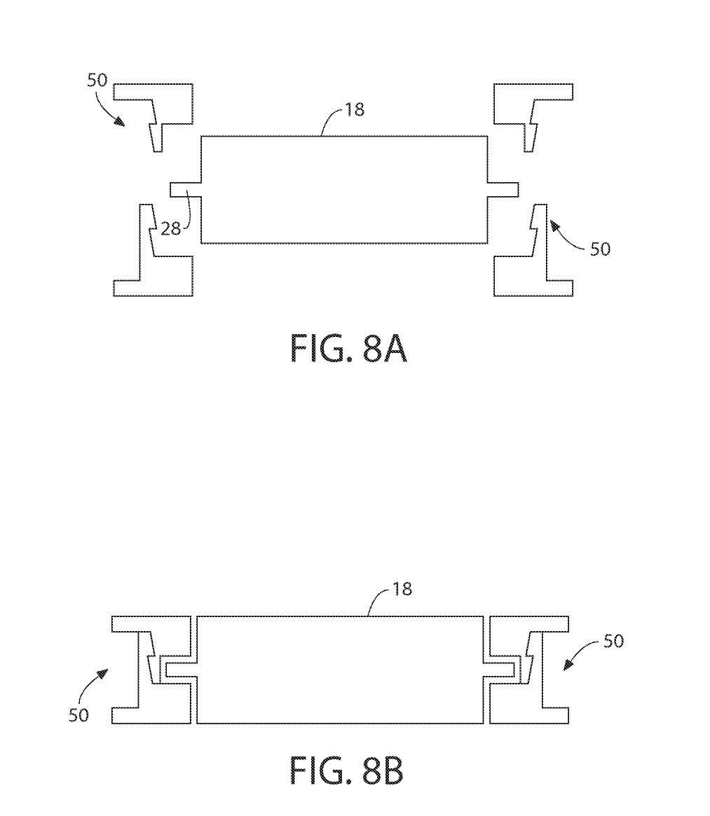

FIGS. 8A-B are views illustrating another alternative embodiment of the invention having a snap lock connection, generally designated 80, for use with a tray (not shown) having an aperture formed there through.

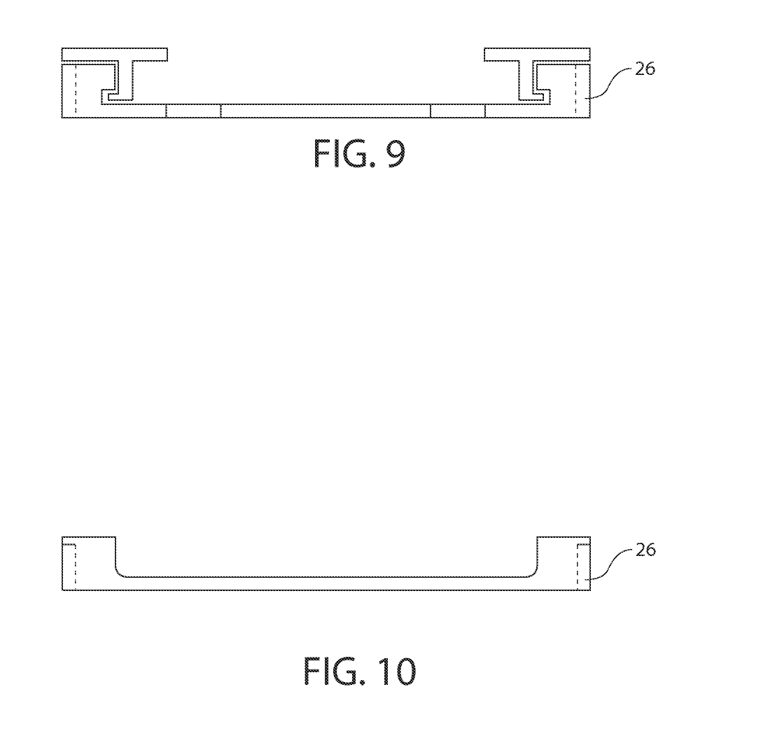

FIG. 9 is a view illustrating a permanent swiveling gear like assembly 18 which can be mounted to either a container 20 or other surface and FIG. 10 is a view illustrating a permanent non-swiveling gear like assembly 18 which can be mounted to either a container 18 or other surface.

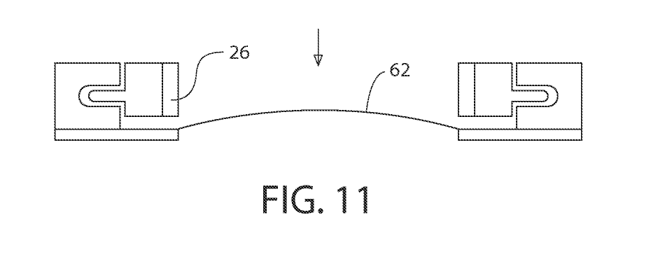

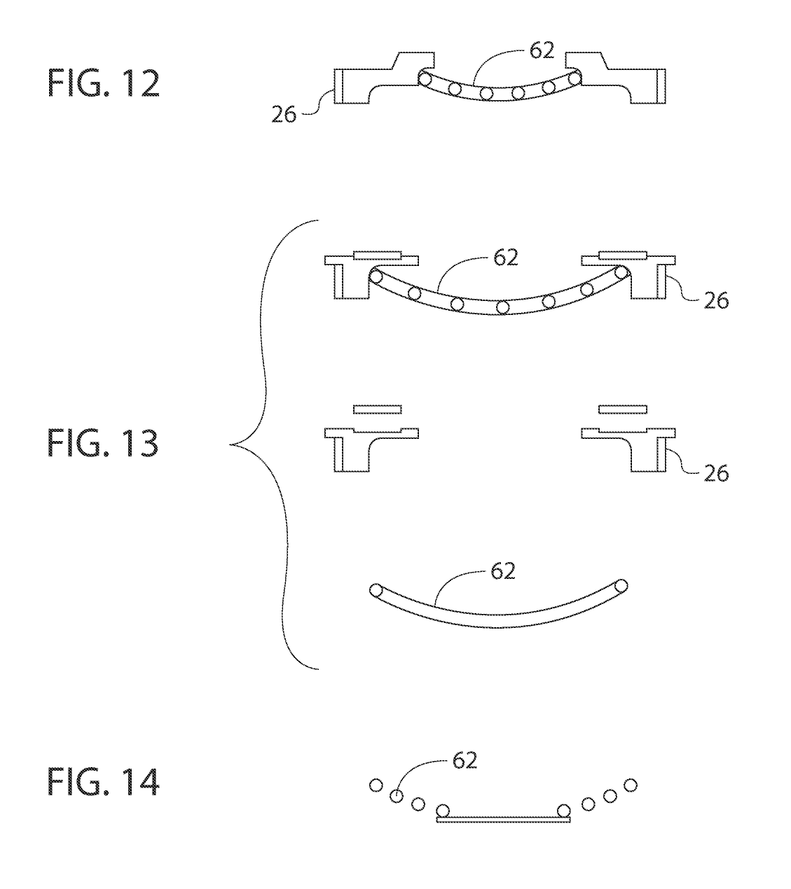

FIGS. 11-14 illustrate a number of alternative embodiments of the invention having a mobile swiveling gear like assembly 18 being held against a surface using a suction type member 62.

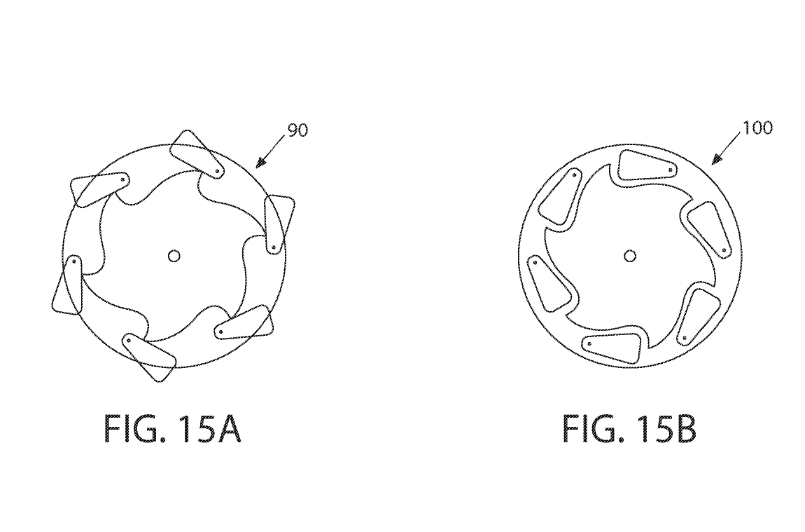

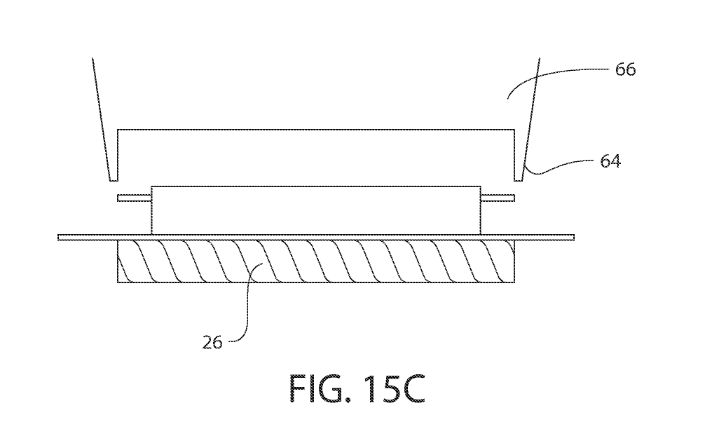

FIGS. 15A-C illustrate two embodiments of the invention for connection to a paper cup. In the embodiment shown in FIG. 16A there is illustrated a mechanism, generally designated 90, that snaps both open and closed to engage the inside of the bottom rim 64 of paper cup 66. In the embodiment shown in FIG. 16B there is illustrated a mechanism, generally designated 100, that is normally closed and snaps open to engage the inside of the bottom rim 64 of paper cup 66.

In each of the embodiments taught herein the container is selected from a group consisting of a glass, formed from either glass or plastic, a plastic cup, a paper cup and a metal container.

The first predetermined width of the generally round hollow member, in the presently preferred embodiment of the invention, will normally be between about 0.125 inch and about 1.00 inch.

Additionally, the first predetermined plurality of teeth are formed on the inner surface of such generally round hollow member and the predetermined location of the annular member disposed on the outer surface of such generally round hollow member is one of closely adjacent a predetermined edge of the generally round hollow member and about midway between the outer edges thereof. In the presently preferred embodiment of the invention, the predetermined location of such annular member is about midway between such outer edges of the generally hollow round member.

The first means is a ledge member which can be formed on a separate piece or as a part of a bore formed in a tray. It would be less costly when the first portion is a tray and the ledge is one of formed as a landing on such tray.

In one presently preferred embodiment of the invention the third means is one of a friction fit and a predetermined plurality of fingers. Further, the first and second predetermined plurality of teeth are identical.

When the first portion is a cup holder disposed in a vehicle and then the apparatus further includes a fourth means having at least a portion thereof disposed on a bottom surface thereof. Such fourth means is selected from an adhesive, preferably a double sided adhesive, and at least one magnet.

While both a presently preferred and several alternative embodiments of the invention have been described in detail above it should be understood that various other arrangements of the components taught herein can be envisioned by those persons skilled in the art without departing from the spirit and scope of the appended claims.

1. An apparatus to substantially minimize accidental tipping of a container partially filled with a liquid, said apparatus comprising:
a) a first portion engageable with at least one of a tray, a coaster, a cup holder disposed in a vehicle, a ladder and said container, said first portion including;
i) a generally round hollow member including each of a first predetermined width, an outer surface having a first predetermined diameter and an inner surface having a second predetermined diameter,
ii) a first predetermined plurality of gear like teeth, having a predetermined pitch, formed at least one of in and on said inner surface of said generally round hollow member,
iii) an annular member disposed on and extending outwardly from said outer surface of said generally round hollow member at a predetermined location, said annular member having a generally rectangular cross section,
iv) a first means having at least a portion of an upper surface thereof disposed below and engageable with a bottom surface of said annular member for each of providing assistance in retaining said generally round hollow member in place and enabling said generally round hollow member to rotate thereover,
v) a second means having at least a portion of a bottom surface thereof disposed above and facing an upper surface of said annular member for providing assistance in retaining said generally round hollow member in place, and
vi) a third means engageable with each of said first means and said second means for maintaining a predetermined distance between said at least a portion of said upper surface of said first means and said at least a portion of said bottom surface of said second means; and
b) a second portion disposed one of in and on one of said tray, said coaster and said cup holder when said first portion is disposed on said container when said first portion is disposed one of in and on said one of said tray, said coaster and said cup holder, said second portion having a second predetermined plurality of gear like teeth disposed on a generally round member disposed on an outer surface thereof and having said predetermined pitch for mating engagement with said first predetermined plurality of teeth.

2. An apparatus, according to claim 1, wherein said container is selected from a group consisting of a glass, a plastic cup, a paper cup and a metal container.

3. An apparatus, according to claim 2, wherein said first predetermined width of said generally round hollow member is between about 0.125 inch and about 1.00 inch.

4. An apparatus, according to claim 2, wherein said first predetermined plurality of teeth are formed on said inner surface of said generally round hollow member.

5. An apparatus, according to claim 1, wherein said predetermined location of said annular member disposed on said outer surface of said generally round hollow member is one of closely adjacent a predetermined edge of said generally round hollow member and about midway between outer edges thereof.

6. An apparatus, according to claim 5, wherein said predetermined location of said annular member disposed on said outer surface of said generally round hollow member is about said midway between outer edges of said generally hollow round member.

7. An apparatus, according to claim 1, wherein said first means is a ledge.

8. An apparatus, according to claim 7, wherein said first portion is a tray and said ledge is one of formed as a landing on said tray and as a separate element engaged with said tray.

9. An apparatus, according to claim 8, wherein said first portion is a tray and said ledge is formed as a separate element engaged with said tray.

10. An apparatus, according to claim 1, wherein said first means is a ledge.

11. An apparatus, according to claim 7, wherein said first portion is a tray and said ledge is one of formed as a landing on said tray and as a separate element engaged with said tray.

12. An apparatus, according to claim 1, wherein said second means is a ledge formed as a separate element engaged with said first portion.

13. An apparatus, according to claim 12, wherein said ledge is formed as a separate element engaged with said first portion.

14. An apparatus, according to claim 1, wherein said third means is one of a friction fit and a predetermined plurality of fingers.

15. An apparatus, according to claim 14, wherein said third means is a plurality of fingers.

16. An apparatus, according to claim 1, wherein said first and said second predetermined plurality of teeth are identical.

17. An apparatus, according to claim 1, wherein said first portion is a cup holder disposed in a vehicle and said apparatus further includes a fourth means having at least a portion thereof disposed on a bottom surface thereof.

18. An apparatus, according to claim 17, wherein said fourth means is selected from an adhesive and at least one magnet.

19. An apparatus according to claim 18, wherein said fourth means is said adhesive.

20. An apparatus, according to claim 19, wherein said adhesive is double sided tape.
